(19) United States
(12) Patent Application Publication
(10) Pub. No.: US 2011/0132160 A1
(43) Pub. Date: Jun. 9, 2011

(54) HAND TOOLS AND RELATED METHODS

(76) Inventor: John C. Zimmerman, La Mesa, CA (US)

(21) Appl. No.: 12/634,605

(22) Filed: Dec. 9, 2009

(51) Int. Cl. B26D 1/00; B23D 49/00; B27B 21/02

(52) U.S. Cl. 83/13; 30/392; 30/514

(57) ABSTRACT

Hand-operated tools; such as hand saws, knives, and files, having improved features for enhancing use thereof are disclosed. The hand tools include one or more recoil members and are adapted to absorb motion of the hand tool in a first direction, and to supplement motion of the hand tool in a second direction. A method for use of an improved hand tool is disclosed, the method includes hand tools adapted with recoil members.

### FIELD OF THE INVENTION

The present invention relates to hand-operated tools, and more particularly to hand-operated tools useful for cutting, abrading, or severing an article.

### BACKGROUND OF THE INVENTION

Hand-operated tools have survived centuries of use for a number of practical applications. Of these hand-operated tools, hand saws, knives and files have been widely known and used for cutting, abrading and severing objects.

One problem, such as the energy and effort required to effectively utilize hand-operated tools, has remained prevalent in the art. To remedy this problem, the market has made available power-operated tools for use with a wide variety of tasks. These power-operated tools have created a number of additional problems, such as electricity requirements, portability, lifetime of batteries, and costs. Therefore, although power tools achieve a solution to the effort-requirement which has been demonstrated as a long felt need in the art, these power-operated tools are often inefficient alternatives to the manual-operated tools currently available.

Other problems associated with hand-operated tools include limitations associated with precision cutting and manipulation of an article. Because the dynamics of operating a hand-operated tool present limitations such as accurate positioning and maintaining a straight-cut, these tools have been widely discouraged in the art where precision cutting is required. Additionally, there has been very little improvement to hand tools over the last decade.

It would therefore be of immense benefit to provide a hand-operated tool configured to cut, abrade, or sever an article, where the hand-operated tool provides a solution to the above problems in the art.

### SUMMARY OF THE INVENTION

Accordingly, it is an object of the present invention to provide a hand-operated tool adapted to cut, abrade, or sever an article; the tool including a blade having a planar surface and an edge, a handle secured to the blade, a plurality of teeth disposed on the blade, and one or more recoil members. The recoil members can be attached to at least one of the blade, or the handle.

The recoil members generally include a first elongated portion, a second elongated portion, and at least one coil disposed between the first and second elongated portions, and are adapted to absorb motion of the hand-operated tool in a first direction and to supplement recoil motion to the hand-operated tool in a second direction, wherein the first direction is opposite of the second direction. The first elongated portion of the recoil members is further adapted to engage an article, and the second elongated portion of the recoil members is adapted to fixedly secure the recoil members to one of: the blade or the handle of the hand-operated tool.

The recoil members can be affixed to one of a: hand saw, coping saw, miter saw, hack saw, bow saw, hand-file, knife, serrated knife, or other hand-operated apparatus for cutting an article.

In another embodiment, a method is disclosed for enhanced precision cutting of an article using a hand-operated tool, the method including the steps of: (i) providing a hand-operated tool comprising one or more recoil members; (ii) providing an article for cutting, (iii) engaging said article with said hand-operated tool at a cutting edge, (iv) engaging said article with said recoil members, (v) translating said hand-tool in a first direction to direct a potential energy into the recoil members, and (vi) supplementing motion in a second recoil direction, wherein the recoil members are adapted to absorb motion in a first direction, wherein the recoil members are adapted to supplement motion in a second direction, and wherein the second direction is opposite to the first direction.

### BRIEF DESCRIPTION OF THE DRAWINGS

Other advantages and characteristics of the invention will become apparent from the examples illustrated below pertaining to a hand-operated tool and methods for use therewith for which reference will be made to the attached figures, where:

FIG. 1 is a perspective view of a hand-operated saw having a planar blade, a handle attached to the planar blade, and one recoil member attached to the handle.

FIG. 2 is a top view of the hand-operated saw of FIG. 1.

FIG. 3 is a perspective view of a hand-operated saw having a planar blade, a handle attached to the planar blade, and two recoil members attached to the handle.

FIG. 4 is a top view of the hand-operated saw of FIG. 3.

FIG. 5 is a perspective view of a hand-operated saw having a planar blade, a handle attached to the planar blade, and one recoil member attached to the handle; the hand operated saw is a hack saw.

FIG. 6 is a top view of the hand-operated saw of FIG. 5.

FIG. 7 is a perspective view of a hand-operated file having a planar blade, a handle attached to the planar blade, and one recoil member attached to the handle.

FIG. 8 is a prior art illustration of a hand-saw blade, the blade having a planar surface and an edge, wherein a plurality of teeth extend outwardly from the edge.

FIG. 9 is a prior art illustration of a blade having teeth used in hand-operated tools, the teeth are characterized by alternating sizes and the teeth extend outwardly from the blade.

### DETAILED DESCRIPTION OF THE PREFERRED EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these detailed descriptions without departing from the spirit and scope of the present invention.

In a general embodiment, a hand-operated tool is provided; the hand-operated tool includes a blade having a planar surface and an edge, a handle secured to the blade, a plurality of teeth disposed on the blade, and one or more recoil members.

The hand-operated tool can be one of: a hand saw such as a cross-cut saw, rip cut saw, panel saw, back saw, keyhole saw, wallboard saw, flooring saw, fret saw, coping saw, hack saw, mitre saw, bow saw, or a pruning saw, a hand-operated filing tool, a knife, or a serrated knife or similar instrument.

The hand-operated tool includes a blade having a planar surface and an edge. The edge of the blade can be configured with one or more teeth extending from a base to a tip. The teeth can be extended from the edge of the blade, such that the teeth are substantially disposed coplanar with the blade. Alternatively, the teeth can extend from the planar surface of the blade, such that the teeth are substantially disposed orthogonal to the planar surface of the blade. The teeth are further adapted to extend from a base to a tip, where the tip is adapted to abrasively-engage an article for cutting, abrading, or severing the article.

The hand-operated tool further includes a handle, wherein the handle is attached to the planar blade of the hand-operated tool. The handle can be fabricated from a metal, polymer, plastic, or wood. The handle can be axially aligned with the blade, such that the blade is coplanar with the handle. The handle can be axially aligned with the blade.

The hand-operated tool further comprises one or more recoil members, wherein the recoil members are adapted to (i) absorb motion of the hand-operated tool along a first direction, and (ii) supplement motion of the hand-operated tool along a second direction. The recoil members generally comprise a first elongate portion, a second elongate portion, and at least one coil disposed between said first and second elongated portions.

The first elongate portion of the recoil member is adapted to be attached to the blade. Alternatively, the first elongate portion of the recoil member is adapted to be attached to the handle. The first elongate portion of the recoil member is further adapted to be disposed within a plane substantially parallel to the blade or the handle.

The second elongate portion of the recoil member is adapted to engage at least one surface of an article. The second elongate portion of the recoil member may further include a padded surface, such that the recoil member is adapted to be engaged with the article in a non-abrasive manner for minimizing the potential for scratching or denting the article.

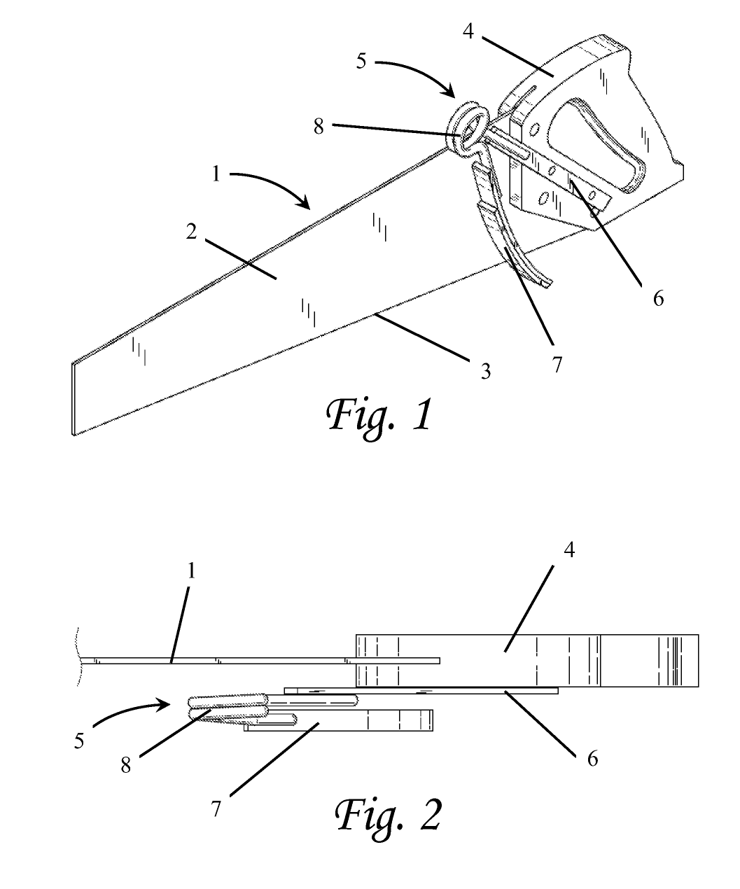

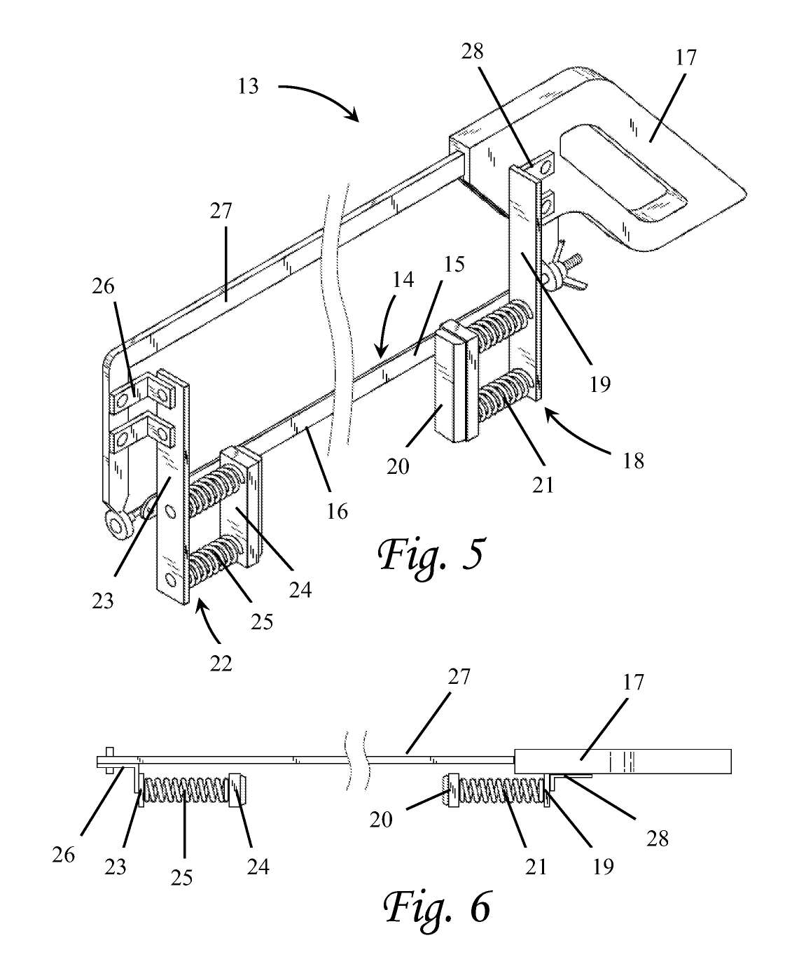

The recoil member further includes at least one coil disposed between the first and second elongate portions. For example, a single coil can be disposed between the first and second elongate portions of the recoil member, wherein the axis of the coil is disposed perpendicular to the blade such that a torsion spring member is formed, see FIGS. 1-4. In another example, a single coil can be disposed between the first and second elongate portions of the recoil member, wherein the coil is axially disposed parallel to the blade, such that a compression spring member is formed, see FIGS. 5-6.

The term “axially disposed” is used to illustrate the various configurations of the coil when describing the recoil members of the invention. Each coil has a substantially annular cross-section with an origin at the center thereof. An axis is established through two or more cross sections of the instant coil, where the axis passes through the origin of the two or more annular cross sections of the coil. A coil is said to be axially disposed parallel to the blade where the axis of the coil is substantially enclosed in a plane parallel to that to the blade. In contrast, a coil is said to be disposed axially perpendicular to the blade where the axis of the coil intersects with the blade in a substantially perpendicular manner. The terms perpendicular and orthogonal are used interchangeably within the specification.

Alternatively, two or more coils can be disposed between the first and second elongate portions of the recoil member for increased absorbed motion in a first direction, and increased supplemental motion in a second recoil direction.

In one embodiment, a single recoil member is configured on one side of the blade. In another embodiment, a first recoil member is positioned on a first side of the blade, and a second recoil member is positioned on an opposite side of the blade. In yet another embodiment, a pair of recoil members are configured to oppose each other along an axial direction parallel to the blade. In yet another embodiment, two pairs of recoil members are provided, each pair of recoil members are configured to oppose each other along an axial direction parallel to the blade, a first pair of recoil members is positioned on a first side of the blade, and a second pair of recoil members is positioned on a second side of the blade.

Now referring to FIGS. 1 and 2, a hand-operated tool is provided. The hand-operated tool is a hand saw, and includes a blade 1 having a planar surface 2 and an edge 3, a handle 4 secured to the blade 1, a plurality of teeth disposed on the blade 1, and a recoil member 5. The recoil member 5 includes a first elongate portion 6, a second elongate portion 7, and a coil 8 disposed between the first and second elongate portions. The coil 8 of the recoil member 5 is axially disposed perpendicular to the blade 1, forming a torsion spring member. The first elongate portion 6 of the recoil member is connected to the handle 4 of the hand-operated tool. A pad is connected to the second elongate portion 7 of the recoil member for engaging an article in a non-abrasive fashion.

A torsion spring member 5 can further include a first elongate portion 6 for connecting the torsion spring member 5 to one of the blade 1 or the handle 4, a second elongate portion 7 for engaging an article, a coil 8 disposed between the first and second elongate portions 6, 7, the coil 8 disposed axially perpendicular to the blade 1 and the handle 4, an impact extension, and a pad. The impact extension can be fabricated from a metal, wood, or a polymer. The pad can be fabricated from a rubber, polymer, fabric, or other non-abrasive material.

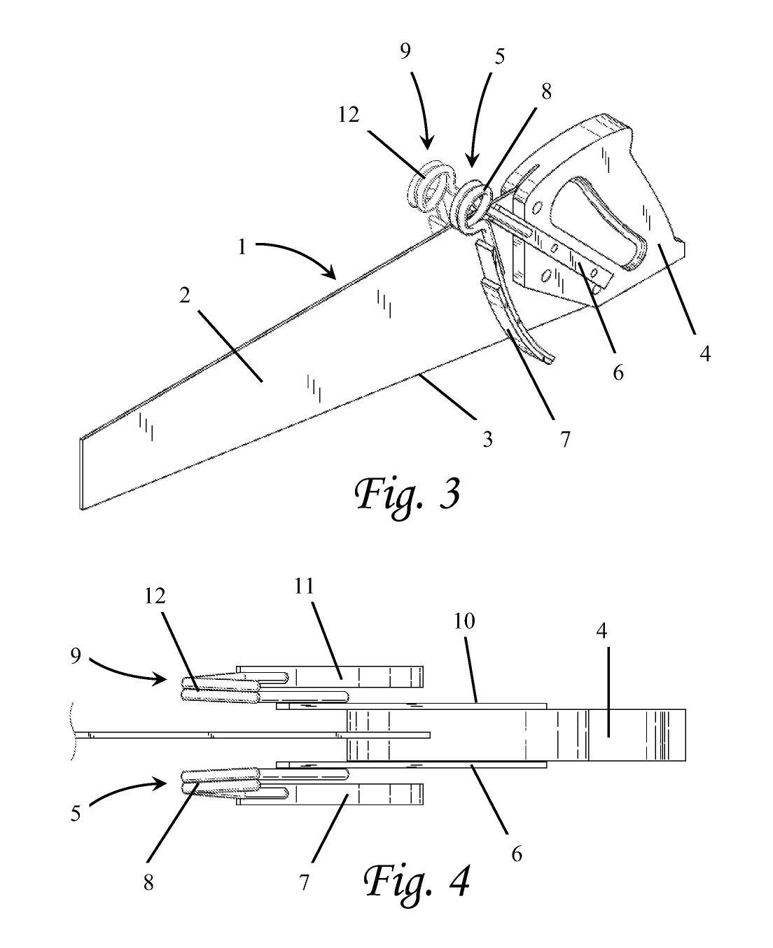

FIGS. 3 and 4 illustrate the hand-operated tool of FIGS. 1 and 2 further comprising a second recoil member 9. In this embodiment, the hand tool includes a blade 1 having a planar surface 2 and an edge 3, a handle 4 secured to the blade, a plurality of teeth disposed on the blade 1, and two recoil members 5, 9. Of the two recoil members 5, 9, a first recoil member 5 is attached to the handle 4 on a first side of the blade 1, and a second recoil member 9 is attached to the handle 4 on a second side of the blade 1. Each of the recoil members 5,9 are axially disposed parallel to the handle 4 and the blade 1. The recoil members 5, 9 are illustrated in the form of torsion spring members; however compression spring members can be implemented in a similar fashion.

The first recoil member 5 includes a first elongate portion 6, a second elongate portion 7, and a coil 8 disposed therebetween. The second recoil member similarly includes a first elongate portion 10, a second elongate portion 11, and a coil 12 disposed therebetween. In this embodiment, the two recoil members are adapted to collectively absorb motion along a first direction, and are further adapted to supplement recoil motion in a second direction, wherein the second direction is opposite of the first direction.

FIGS. 5 and 6 illustrate a hand-operated tool, wherein the hand-operated tool is a hack saw 13. The hack saw 13 includes a blade 14 having a planar surface 15 and an edge 16, a handle 17 secured to the blade 14, a plurality of teeth disposed on the blade 14, and a pair of opposing recoil members 18, 22. The pair of recoil members 18, 22 are configured to oppose each other, and are axially disposed parallel to the handle 17 and the blade 14. The recoil members 18, 22 are illustrated in the form of compression spring members, however torsion spring members can be implemented in a similar fashion. The recoil members 18, 22 are attached to the handle, however in an alternative embodiment the recoil members can be attached to the blade, or a frame 27 or containing the blade 14. As illustrated in FIGS. 5 and 6, a single pair of recoil members 18, 22 can be positioned on a first side of the blade 14.

In an alternative embodiment, a first pair of compression spring recoil members 18, 22 can be configured on a first side of the blade as illustrated in FIGS. 5 and 6, and a second pair of recoil members can be positioned on a second side of the blade (not illustrated), where the second side of the blade is opposite of the first side.

A compression spring member 18, 22 can further include a first elongate portion 19, 23 for connecting the compression spring member 18, 22 to one of the blade 14, frame 27, or the handle 14; a second elongate portion 20, 24 for engaging an article, and at least one coil 25 disposed between the first and second elongate portions; the coil 25 disposed axially parallel to the blade 14 and the handle 17. The second elongate portion can include an impact bar 24, and a pad 20. The impact bar 24 can be fabricated from a metal, wood, or a polymer. The pad 20 can be fabricated from a rubber, polymer, fabric, or other non-abrasive material. Preferably, two or more coiled springs 25 are symmetrically configured between the first and second elongate portions 19, 20; 23, 24 of the compression spring member.

Where the hand-operated tool includes a frame 27, as illustrated in FIGS. 5 and 6, each recoil member 18, 22 can be individually connected to one of the handle 17, blade 14, or the frame 27 of the hand-operated tool. Generally, a hack saw, coping saw, bow saw, mitre saw, and fret saw include a frame, and are capable of attaching to one or more recoil members at the frame.

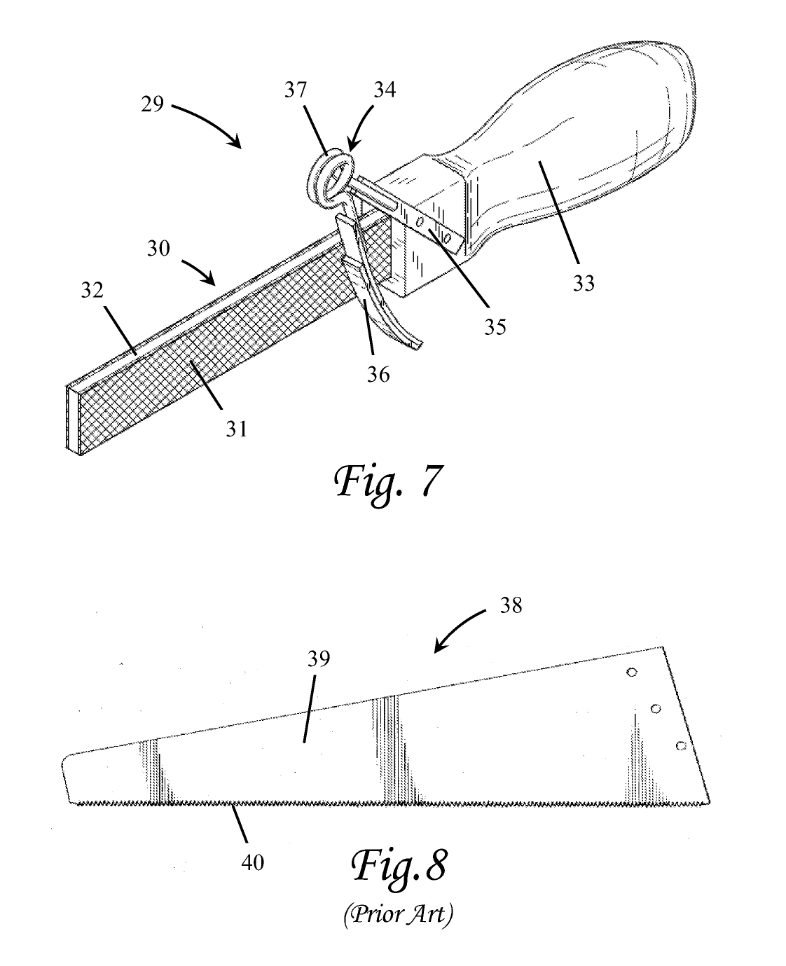

FIG. 7 provides a hand-operated filing tool, the hand-operated file 29 including a blade 30 having a planar surface 31 and an edge 32, a handle 33 fixedly secured to the blade 30, a plurality of teeth disposed on the blade, and a recoil member 34. The recoil member 34 is attached to a first side of the blade 30 at the handle 33. In this embodiment, the recoil member 34 is a torsion spring member; however a compression spring member can be utilized in a similar fashion in accordance with the above examples. The recoil member 34 is axially disposed parallel to the blade 30, however in another embodiment the recoil member can be axially disposed perpendicular to the blade simply by attaching the recoil member 34 to the handle 33 at a position 90 degrees relative to that illustrated in FIG. 7. The hand-operated filing tool can further be adapted to include two or more recoil members, a pair of opposing recoil members, or two or more pairs of opposing recoil members.

FIG. 8 illustrates a prior art hand saw blade 38 having a substantially planar surface 39, and a plurality of teeth disposed along an edge 40. One having ordinary skill in the art will recognize that a variety of patterns for disposing teeth along one of the edge, or the planar surface of the blade, are widely disclosed in the art. U.S. Pat. No. 4,590,837 describes the blade and teeth as illustrated in FIG. 8, the entire contents of which are hereby incorporated by reference.

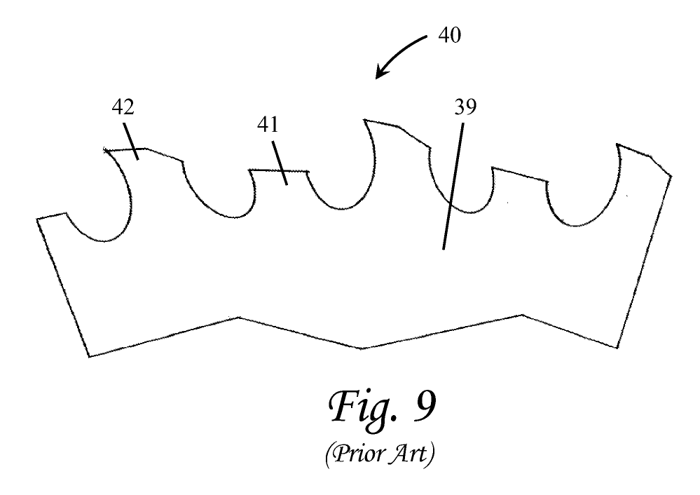

FIG. 9 is another prior art illustration of a blade 40 compatible with hand tools, the blade 40 having a planar surface 39 and an edge, wherein a plurality of teeth 41; 42 extend from the edge of the blade. In this embodiment, the teeth are disclosed as having different sizes and positions for abrasive cutting of an article. The teeth are disposed in a pre-determined manner, and extend from a base to a tip. This embodiment is disclosed in US 2002/0194975, and illustrates additional prior art teachings related to teeth for hand-operated tools, the entire contents of which are hereby incorporated by reference.

In another embodiment of the invention, a method is disclosed for enhanced precision cutting of an article using a hand-operated tool, the method including the steps of: (i) providing a hand-operated tool comprising one or more recoil members; (ii) providing an article for cutting, (iii) engaging said article with said hand-operated tool at a cutting edge, and (iv) engaging said article with said recoil members, wherein said recoil members are adapted to absorb motion in a first direction, and wherein said recoil members are adapted to supplement motion in a second direction.

In another embodiment, a method is disclosed for enhanced precision cutting of an article using a hand-operated tool, the method including the steps of: (i) providing a hand-operated tool comprising one or more recoil members; (ii) providing an article for cutting, (iii) engaging said article with said hand-operated tool at a cutting edge, (iv) engaging said article with said recoil members, (v) translating said hand-tool in a first direction to direct a potential energy into the recoil members, and (vi) supplementing motion in a second recoil direction, wherein the recoil members are adapted to absorb motion in a first direction, wherein the recoil members are adapted to supplement motion in a second direction, and wherein the second direction is opposite to the first direction.

The above examples are set forth for illustrative purposes and are not intended to limit the spirit and scope of the invention. One having skill in the art will recognize that deviations from the aforementioned examples can be created which substantially perform the same task and obtain similar results. Additionally, the recoil members of the present invention can be attached to any member or component of the hand-operated tool, in any fashion for providing a tool adapted for enhanced precision cutting of an article.

I claim:

1. A hand-operated tool, comprising:
a blade having a planar surface and an edge,
a handle secured to said blade,
a plurality of teeth disposed on said blade in a predetermined pattern with each of said teeth extending from a base to a tip, and
one or more recoil members attached to one of: said blade, or said handle;
wherein said recoil members are adapted to absorb motion of the hand tool in a first direction, and
wherein said recoil members are further adapted to supplement motion of the hand tool in a second direction.

2. The hand-operated tool of claim 1, wherein said blade is axially aligned with said handle.

3. The hand-operated tool of claim 1, wherein said teeth are extended from said planar surface of said blade.

4. The hand-operated tool of claim 3, wherein said tool is a file.

5. The hand-operated tool of claim 1, wherein said teeth extend from said edge of said blade.

6. The hand-operated tool of claim 6, wherein said tool is a hack saw.

7. The hand-operated tool of claim 6, wherein said tool is a back saw.

8. The hand-operated tool of claim 6, wherein said tool is a knife.

9. The hand-operated tool of claim 1, wherein said recoil members are selected from the group consisting of: a torsion spring member and a compression spring member.

10. The hand-operated tool of claim 9, wherein said torsion spring member further comprises:
a first elongated portion,
a second elongated portion, and
a coil disposed between said first and second elongated portions.

11. The hand-operated tool of claim 10, wherein said first elongated portion is connected to said handle.

12. The hand-operated tool of claim 10, wherein said first elongated portion is connected to said blade.

13. The hand-operated tool of claim 9, wherein said compression spring member further comprises:
a first elongated portion,
a second elongated portion, and
at least one coil spring disposed between said first and second elongated portions.

14. The hand-operated tool of claim 13, wherein said first elongated portion is connected to said handle.

15. The hand-operated tool of claim 13, wherein said first elongated portion is connected to said blade.

16. A method for enhanced precision cutting of an article using a hand-operated tool, the method comprising the steps of:
(i) providing a hand-operated tool comprising one or more recoil members,
(ii) providing an article for cutting,
(iii) engaging said article with said hand-operated tool at a cutting edge, and
(iv) engaging said article with said recoil members,
(v) translating said hand-tool in a first direction to direct a potential energy into the recoil members, and
(vi) supplementing motion in a second recoil direction.
